(19) United States
(12) Patent Application Publication
(10) Pub. No.: US 2006/0084473 A1
(43) Pub. Date: Apr. 20, 2006

(54) Base station architecture

(75) Inventors: Ossi Pollanen, Espoo (FI); Juha T. Heikkila, Espoo (FI); Hannu Vaitovirta, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/249,349

(22) Filed: Oct. 14, 2005

(30) Foreign Application Priority Data
Oct. 14, 2004 (FI) 20045390

(51) Int. Cl. H04B 1/38

(52) U.S. Cl. 455/561

(57) ABSTRACT

The invention relates to a macro base station, comprising at least one module for implementing the base station functionality between external interfaces of the base station, wherein the module is mountable as one unit.

### FIELD OF THE INVENTION

The invention relates to architecture of a base station in a radio network.

### BACKGROUND OF THE INVENTION

Base stations of radio networks often need to be designed by taking into account possible future extension needs. That is achieved with the typical base station architecture incorporating from the outside an outdoor cabinet, an indoor cabinet, a subrack, a printed circuit board unit and a chip. Individual functional entities, such as a power amplifier and a base band processing unit, are individually mounted in the base station subrack and appropriate wiring is implemented between the units. Extensionability of the base station is achieved by providing large enough cabinets so that units and wiring can later on be added to the base station.

The current base station architecture has disadvantages in that the installation of a base station is time and thus money consuming due to the complicated structure of the base station. Furthermore, base station cabinets are often over-dimensioned, which results in that precious space is wasted in the base station sites and a lot of wiring is needed between the units. Thus, it is clear that alternative base station architecture is needed.

### BRIEF DESCRIPTION OF THE INVENTION

An object of the present invention is thus to provide an enhanced base station structure. In one aspect of the invention, there is provided a macro base station, comprising at least one module for implementing the base station functionality between external interfaces of the base station, wherein the module is mountable as one unit.

In another aspect of the invention, there is provided a base station module, comprising means for communication over a radio interface towards a radio antenna, means for communicating over a radio network interface towards a radio network controller, wherein the module, mountable as one unit, is configured to provide the base station functionality between the two interfaces.

The preferred embodiments of the invention are disclosed in the dependent claims.

The invention thus relates to a structure of macro base station. As contrary to the prior art base station wherein the functionality is distributed to different functional entities, the invention suggests a base station structure wherein the base station functionality is incorporated into a macro base station module mountable as one unit at a base station site.

The base station according to the invention can be a WCDMA (Wideband Code Division Multiple Access) base station, for instance. In another embodiment, the base station is a GSM (Global System for Mobile Communication), wherein a WCDMA module is mountable. Thereby the existing GSM base stations can easily be updated to also provide newer technology.

The invention is based on the idea of providing at least one mountable module to a base station in a mobile communication network. The module according to the invention is such that it includes all the functionality between two external interfaces of the module, wherein one of the interfaces can lead to an antenna and the other interface towards a radio network controller. In the case of a WCDMA network, the radio network interface in conjunction with the invention need not necessarily be the interface providing the lub interface. The radio network interface can also be another interface closer to the radio signal processing functionality. In other words, there can be interfaces or functional units between the lub interface and the radio network interface of the invention.

The modular structure of the base station and base station site enables distributing of modules to suitable places at the base station site. The modules can, for example, be placed such that there is one module in close proximity to each antenna. Thereby the need for valuable space at the site can be distributed and a need for a large base station cabin can be avoided.

In one embodiment of the invention, the module comprises means for receiving a base band signal, means for converting the base band signal into a small radio frequency signal, a power amplifier for amplifying the small radio frequency signal, a radio frequency filter for filtering the amplified radio frequency signal, and means for outputting the filtered radio frequency signal via the interface towards the antenna.

In another embodiment of the invention, the module comprises means for receiving a radio frequency signal via the first interface towards a receiving antenna, means for converting the received radio frequency signal into a base band signal and means for outputting the base band signal via the second external interface toward a radio network controller.

In one embodiment of the invention, the module functionality is provided on a single piece of casting mechanics.

In another embodiment of the invention, the module comprises integrated cooling, meaning that each module includes cooling means of its own. The cooling can be implemented by fresh air cooling. The arrangement of the module can be such that the power amplifiers providing most of the heat are cooled by the outlet air. The baseband electronics can be incorporated into the casting mechanics and be thus cooled by heat convection instead of air flushing.

In still another embodiment of the invention, the base station module comprises at least one semiconductor chip for performing part of the radio signal processing, the semiconductor chip being incorporated into and mechanically supported by a plastic body, wherein the plastic body is incorporated into and mechanically supported by a body of the module. The simple mechanical structure of the module enhances cooling of the base station unit, because the cooling air does not need to traverse through several mechanical layers. The module can be such that it readily fulfils tightness requirements of the environment wherein the base station is to be installed. The environmental protection requirement in the case of base stations can be IP55, for instance, defining that the module is suitable for indoor/outdoor use.

In one embodiment of the invention, the base station comprises a stand for mounting one or more modules therein. The stand can comprise at least one vertical support element for supporting the module to be mounted along a vertical axis of the module. Vertical assembly saves space, which is very important in often very crowded base station sites. The stand enabling vertical assembly of the modules can additionally enable the mounting of base station modules on both sides of the vertical support element.

The invention provides a simple base station structure, wherein functional units for implementing a carrier functionality can be mounted in the base station as a single unit, thereby providing considerable savings in assembly time and in the space needed by the base station.

### BRIEF DESCRIPTION OF THE DRAWINGS

In the following, the invention will be described in greater detail by means of preferred embodiments with reference to the attached drawings, in which

FIG. 1 illustrates one embodiment of a base station according to the invention;

FIG. 2 illustrates another embodiment of a base station according to the invention;

FIG. 3 shows one embodiment of a base station module according to the invention;

FIG. 4 shows an embodiment of a base station stand, and

FIG. 5 shows another embodiment of a base station stand.

### DETAILED DESCRIPTION OF THE INVENTION

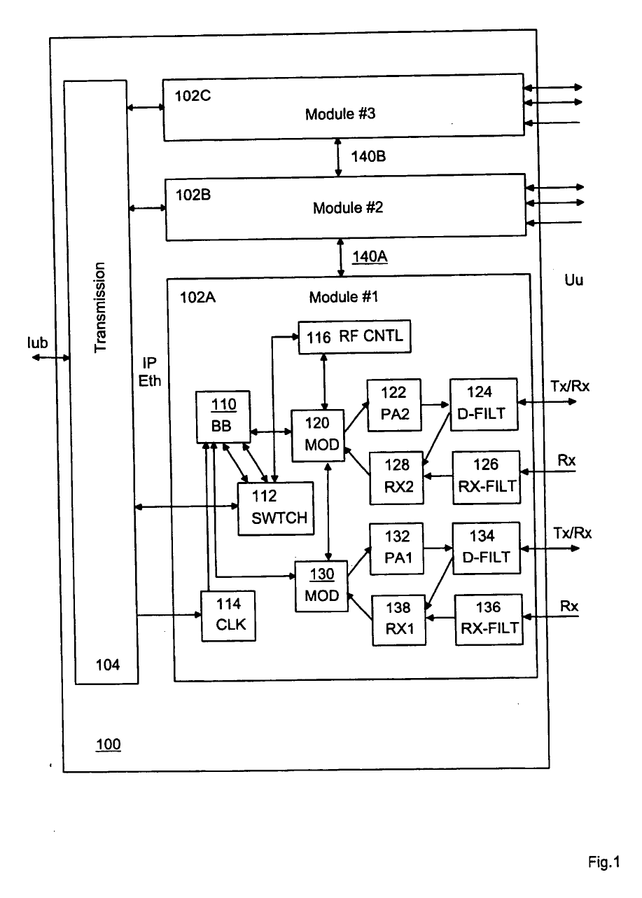

FIG. 1 shows one embodiment of a base station 100 according to the invention. The base station as illustrated in FIG. 1 can be defined to be a functional entity that performs the functionality between a radio interface and a radio network controller interface. The base station can, for instance, be a WCDMA base station, in which case the radio interface towards the mobile terminals is called a Uu interface and the interface towards a radio network controller is called a lub interface. FIG. 1 shows three radio modules 102A, 102B and 102C.

In the embodiment of FIG. 1, the three radio modules are connected to each other by an interface for conveying base band data. In one embodiment, the modules are connected to each other by direct interfaces, out of which interfaces 140A and 140B are shown as an example. The interface can be implemented as a base band bus, for instance. In another embodiment, the base station comprises a transmission unit 104 for conveying data between the modules and between the modules and the radio network controller. The radio network controller interface can utilize packet data transmission, such as the Internet or Ethernet protocol. The module 102A comprises a switch for transmitting, receiving and multiplexing data towards the transmission unit 104.

The module 102 also comprises a base band unit 110 for operating on the base band signal. The modulators 120 and 130 perform conversion between the base band and the radio signal. FIG. 1 shows functional units 120 to 128 for handling one carrier in the base station, whereas units 130 to 138 can handle another carrier.

When transmitting a signal, the modulated signal is conveyed to a power amplifier 122 and from thereon to a duplex filter 124. Thereon, the signal can be conveyed to an antenna of the base station. The receiving signal is filtered in a receiving filter 126 and further processed in a receiver 128. The module 102A also includes a clock 114 for timing the different entities in the module, and a radio controller 116 for controlling processing of radio frequency signals onto different carriers.

The module 102A can also have an external interface towards a site support module, which can provide power or other services for different operating modules of the base station, for instance.

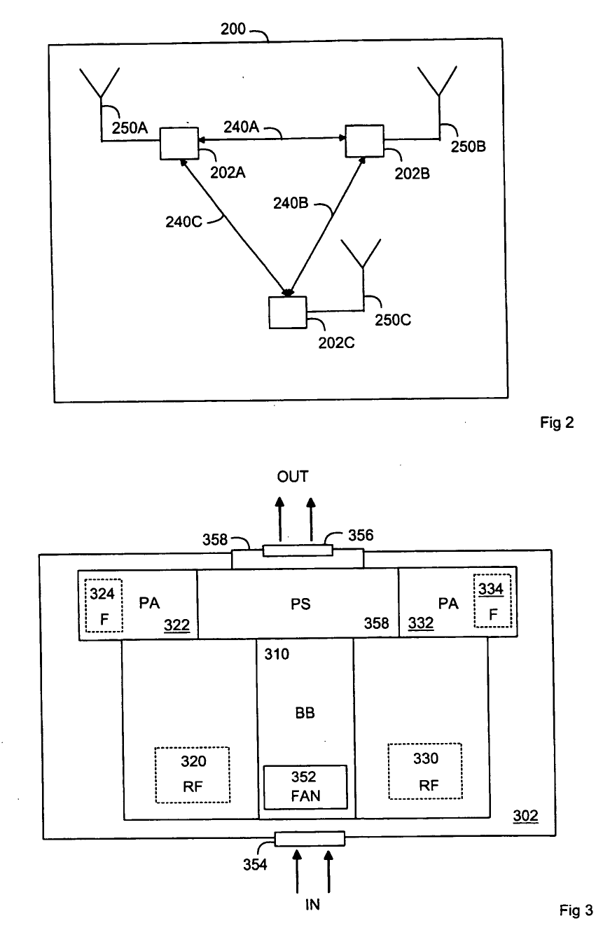

FIG. 2 illustrates another embodiment of a base station 200 or base station site. The base station site according to FIG. 2 includes three transmission antennas 250A, 250B and 250C. The base station site can be placed on top of a building, for instance, whereby the transmission antennas 250A to 250C can be placed on different sides of the building. Each of the transmission antennas could thus cover approximately ⅓ of the total area covered around the building.

As FIG. 2 shows, each transmitting/receiving antenna 250A to 250C has a corresponding base station module 202A to 202C in its proximity. The modular approach of the base station according to FIG. 2 enables a physically distributed base station structure, wherein practically all the functionality is in proximity to the antennas and a separate base station cabin is not needed. FIG. 2 also shows internal interfaces 240A to 240C between the modules 202A to 202C. The internal interfaces are suitable for transmitting base band data so that each module can see each antenna, meaning that each module can transmit/receive data via any antenna so that the combining/splitting functionality of user data flows is possible.

FIG. 3 highlights the mechanical structure of a base station module 302 seen from top. The module can include an air inlet 354 on a first side of the module and an air outlet 356 on the other side of the module. The cooling means 352, such as a fan, can be placed in immediate proximity of the air inlet 354, whereas the module can effectively be cooled by fresh air. When cooling by fresh air, additional cooling elements are not needed within the module. In the embodiment of FIG. 3, the module includes a base band processing means that can be incorporated into the casting mechanics of the module 302. By that it is meant that the casting mechanics includes an essentially closed interior for incorporating the base band electronics. In such a case, the base band electronics can be cooled by heat convection instead of cooling by air flow. The small radio frequency processing means 320 and 330 can be placed close to the first side of the module in the proximity of the fan 352.

The power amplifiers 322 and 334 that create most of the heat produced in the module can be placed close to the air outlet 356 and be thus mainly cooled on air that is exiting the module.

Besides the cooling arrangement of FIG. 3, cooling of the module can be implemented by utilizing advanced heat spreading mechanisms, such as heat pipes, or even liquid cooling.

In one embodiment, the filters 324 and 334 are placed next to the amplifiers so that the amplified signal need not be conveyed a long distance for filtering. The power source can also be close to the second side of the module, the second side also including connecting means 358 for connecting the module to an antenna, for instance.

Mechanically the structure of the module 302 can be such that the base of the module is one piece of casting mechanics. Thereby it can be defined that the module performing the base station functionality can be installed in a base station as one piece. The one piece of casting mechanics can be covered by a metal cover that protects the module. Thereby the units of the module can be included in a common space defined by the cover of the module. The cover can include several pieces, such as a bottom cover, top cover and a cable cover.

The disclosed structure has a small number of mechanical layers and thereby cooling can be improved because heat or cooling air does not need to be transferred through several mechanical layers. The small number of layers also enables implementation of small and advanced cooling solutions close to the heat sources.

Lowering the number of mechanical layers by placing the different functionalities in the same module leads to an increase in the integration level of the electronics. Integrated digital solutions have much shorter distances between components. Short printed circuit board lines have smaller capacitance than lines in a traditional solution passing through several layers of mechanics. Therefore line drivers between digital components can be omitted, which enables component, semiconductor and current consumption savings.

The module can be such that it fulfils environment protection requirements of the environment wherein the module will be mounted. The module can fulfil the IP55 requirement, for instance, so that the module is suitable for indoor and outdoor use.

The module structure according to FIG. 3 is thus such that the whole macro base station functionality and flexibility can be implemented in a very small space, that is, as one module only, including six main functionalities, which are a power supply, a cooling fan, a power amplifier, a radio frequency filter, a base band card and a small signal radio frequency card. The module can support one or more carriers in a base station. FIG. 4 illustrates one embodiment of a base station stand 460 in comparison to a person 470 standing next to the stand. The stand 460 can include one or more vertical support elements, such as 464A and 464B, which are connected to each other by horizontal support elements, such as 466A and 466B. The horizontal support elements can be spaced from each other such that a base station module can be placed between them. The vertical support elements 464A and 464B can be connected to horizontal base elements 468A and 468B, which can be placed on floor of the base station site.

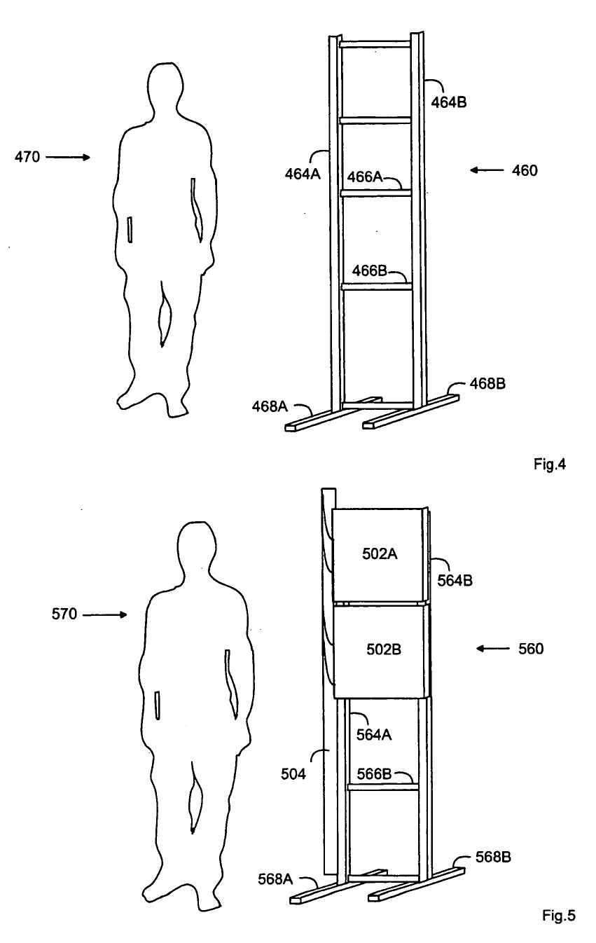

FIG. 5 shows another embodiment of a base station stand 560 structure. In FIG. 5, there are two modules 502A and 502B mounted in the base station stand of the base station site. The base station also includes a base band bus 504 for transmitting base band data between the modules that are mounted in the stand. The modules are assembled vertically, meaning that greater a portion of the mass of the module is in the vertical direction than in the horizontal direction. As can be seen in FIG. 5, the structure of the base station stand and vertical assembly of the modules 502A and 502B consumes very little space. In the illustrated structure, the only wiring needed between the modules is the base band bus for transmitting base band data. In one embodiment, the base station modules can be installed in both sides of the base station stand, whereby even less space is consumed at the base station site.

In still another embodiment of the base station site, the modules can be mounted in one or more walls of the base station site. The modules can be located centrally in the same location at the site or alternatively the modules can be distributed at the site in close proximity to the transmitting/receiving antennas, for instance. In both cases, that is, in the centrally located solution and in the distributed solution, there is a base band bus for conveying base band data between the modules.

It will be obvious to a person skilled in the art that, as the technology advances, the inventive concept can be implemented in various ways. The invention and its embodiments are not limited to the examples described above but may vary within the scope of the claims.

1. A macro base station, comprising:
at least one module for implementing a base station functionality between external interfaces of the base station, wherein
the at least one module is mountable as one unit.

2. A macro base station according to claim 1, wherein
the external interfaces include a radio network controller interface and a radio antenna interface.

3. A macro base station according to claim 1, wherein the at least one module is provided on a single piece of casting mechanics.

4. A macro base station according to claim 1, wherein a single piece of casting mechanics providing a base for module functionality and is at least partly covered by one or more cover elements.

5. A macro base station according to claim 1, wherein the base station comprises at least two modules, wherein the at least two modules are connected to each other via an interface configured for communication of base band data.

6. A macro base station according to claim 1, wherein the at least one module comprises means for cooling, the cooling means being configured to cool the module by fresh air cooling.

7. A macro base station according to claim 1, wherein the at least one module comprises:
means for inputting cooling air into the module from a first side of the module;
means for outputting air from the module via a second side of the module;
means for processing a radio signal; and
means for amplifying the processed radio signal, wherein the radio signal processing means is placed next to the first side of the module and the amplifying means is placed next to the second side of the module.

8. A macro base station according to claim 1, wherein the module comprises a means for processing a base band signal, the base band signal processing means being cooled by heat convection.

9. A macro base station according to claim 2, wherein the radio network controller interface is connected to a transmission unit configured to provide communication between at least two modules.

10. A macro base station according to claim 1, wherein the at least one module comprises:
timing means for timing at least one unit in the module;
cooling means for cooling at least one unit in the module;
means for providing conversion between base band and radio frequency data formats;
means for amplifying a radio frequency signal; and
means for filtering the radio frequency signal.

11. A macro base station according to claim 1, wherein the at least one module comprises means for connecting the module as one unit to a GSM base station cabin.

12. A macro base station according to claim 1, wherein the base station is a WCDMA base station.

13. A macro base station according to claim 1, wherein the at least one module is a WCDMA module.

14. A macro base station according to claim 1, wherein the at least one module is configured to implement functionality between an interface to a radio network (lub interface) and an interface to a mobile terminal (Uu interface) of a WCDMA base station.

15. A macro base station according to claim 1, wherein the macro base station comprises at least two antennas physically distributed from each other, and at least two modules, wherein each antenna has a module in immediate proximity thereof.

16. A macro base station according to claim 1, further comprising a site support unit that provides at least one support function for the at least one module.

17. A macro base station according to claim 1, wherein the at least one module comprises:
means for receiving a base band signal via a packet data interface;
means for converting the base band signal into a radio frequency signal;
a filter for filtering the radio frequency signal;
a power amplifier for amplifying the radio frequency signal; and
means for outputting the filtered radio frequency signal to an antenna interface.

18. A macro base station according to claim 1, wherein the at least one module comprises:
means for receiving a radio frequency signal via the radio antenna interface;
means for converting the radio frequency signal into a base band signal; and
means for outputting the base band signal to a packet data interface.

19. A macro base station according to claim 1, wherein each module of the at least one module is configured to fulfil environmental protection requirements of the site of the macro base station.

20. A base station according to claim 1, wherein the at least one module further comprises means for attaching the module to the wall of the site of the base station.

21. A macro base station according to claim 1, wherein the macro base station further comprises a stand, the stand comprising at least one vertical support element for supporting the at least one module to be mounted along a vertical axis of the at least one module.

22. A macro base station according to claim 21, wherein the vertical support element is configured to support one vertically mounted module on each side of the vertical support element.

23. A base station module, comprising:
means for communication over a radio interface to a radio antenna; and
means for communicating over a radio network interface to a radio network controller, wherein
the module, is configured to provide base station functionality between the radio interface and the radio network interface, and is mountable as one unit.
